(19) United States
(12) Patent Application Publication
(10) Pub. No.: US 2014/0093754 A1
(43) Pub. Date: Apr. 3, 2014

(54) High-Temperature Resistant Carbon Monofluoride Batteries Having Lithiated Anode

(71) Applicants: Robert J. Hamers, Madison, WI (US); Joseph C. Yeager, Madison, WI (US)

(72) Inventors: Robert J. Hamers, Madison, WI (US); Joseph C. Yeager, Madison, WI (US)

(21) Appl. No.: 13/644,098

(22) Filed: Oct. 3, 2012

(51) Int. Cl. H01M 4/38; H01M 6/16

(52) U.S. Cl. CPC H01M 4/386; H01M 6/162
USPC 429/50; 429/231.95; 429/188; 429/199

(57) ABSTRACT

Disclosed are carbon monofluoride cathode batteries suitable for use at highly elevated temperatures. Rather than using a pure lithium anode, the anode has a base material selected from the group consisting of silicon, germanium and tin, where the base material is lithiated. This renders the anode more resistant to heat. Selected electrolytes are used which also contain lithium salts. Methods for using these batteries at high temperatures are also disclosed.

### STATEMENT REGARDING FEDERALLY SPONSORED RESEARCH/DEVELOPMENT

This invention was made with government support under ______ awarded by the National Science Foundation. The government has certain rights in the invention.

### CROSS-REFERENCE TO RELATED APPLICATIONS

Not applicable.

### BACKGROUND OF THE INVENTION

The present invention relates to lithiated anode/carbon monofluoride cathode batteries that are suitable to operate at highly elevated temperatures.

In developing batteries one often seeks to achieve high voltage capability, store substantial amounts of energy, operate reliably and safely, provide energy on a timely response basis, keep the cost of the battery materials within commercially practical limits, provide a battery that operates long term without significant maintenance issues, and also keep the weight of the battery low.

One type of commercially useful battery has a lithium metal anode and a carbon monofluoride cathode. “Carbon monofluoride”, which is often abbreviated as “CFₓ”, is typically formed by a carbon substrate (such as graphite powder) having been exposed to fluorine gas at high temperature. This creates a material where fluorine is intermixed with carbon at a molar ratio near 1 to 1, but usually not exactly at 1 to 1. These materials often range from CF_{0.68} to CF_{1.12}, yet still are collectively referred to as “monofluoride”. That nomenclature will be used herein as well.

FIG. 1 depicts a prior art type of Li/CFₓ battery, of the coin cell/button type. It has a CFₓ cathode 12, a lithium anode 13, a metal current collector 14 attachable along a side of the cathode 12, and a separator 15 impregnated with (and adjacent) electrolyte 16. There may also be metal spacers 17, a spring 18, a gasket 19, and outer casings 20 and 21. The separator may be polyethylene impregnated with a mixture of polypropylene carbonate, 1,2 dimethoxyethane, and lithium tetrafluoroborate salt.

While this type of prior art battery is useful for a variety of applications, it is not well suited for long term use at temperatures above 100° C. This is significant as there are various industrial and military applications for non-rechargeable batteries which would benefit if their batteries were better able to operate at higher temperatures (without significantly compromising other performance characteristics).

For example, in a number of oil drilling applications various battery powered devices (e.g. cameras; sensors) are used at or near the bottom of the drilled area. This can expose the device to geothermal heating extremes.

As another example, in a battlefield environment military devices can become exposed to heat generated by explosions. It is desirable for those devices (e.g. their power sources) to have improved survivability in the face of such transient heat exposure.

A variety of organosilicon based electrolytes, and methods for producing them, have previously been described. See e.g.:
(a) hydroxy terminated: Me₃Si—(CH₂)ₘ—(OCH₂CH₂)_{n—OH: WO} 2011/136990.
(b) Si—O—C linkage to ethylene glycol chain: Me₃Si—O—(CH₂CH₂O)ₙ—Me: WO 2011/142896.
(c) dimer forms of Si—O—C linkage to ethylene glycol chains: Me—O—(CH₂CH₂O)ₙ—Si (CH₃)₂—O—(CH₂CH₂O)ₙ—Me: WO 2011/142896.
(d) multiple SiMe₃ termini: Me₃Si—O—(CH₂CH₂O)ₙ—SiMe₃: WO2011/142896 (e.g. paragraph 14).

In WO 2011/142896 there was a disclosure of how batteries with a carbon monofluoride cathode, a lithium anode, and such organosilicon electrolytes (with lithium salts) could be used at 130° C. However, as temperatures increased to above 150° C. the battery's capacity began to fall off. Further, as bare lithium metal tends to melt at 180° C., use of such batteries above those temperatures was impractical.

There have also described anodes made of silicon, germanium or tin, where these materials have been lithiated. See generally N. Liu et al., Prelithiated Silicon Nanowires As An Anode For Lithium Ion Batteries, ACSNANO.ORG (2011); X Liu et al., Reversible Nanopore Formation In Ge Nanowires During Lithiation—Delithiation Cycling: An In Situ Transmission Electron Microscopy Study, 11 Nano Lett. 3991-3997 (2011); A. Karnali et al., Tin-Based Materials As Advanced Anode Materials For Lithium Ion Batteries: A Review, 27 Rev. Adv. Mater. Sci. 14-24 (2011); and R. Ruffo et al., Impedence Analysis Of Silicon Nanowire Lithium Ion Battery Anodes, 113 J. Phys. Chem. 11390-11398 (2009). However, various lithiated anodes suffered from production or reliability concerns, and in any event have not been proposed for use in ultra high temperature CFₓ cathode environments.

Hence, there is a need for improved carbon monofluoride batteries, particularly with respect to capability for high temperature operation.

### SUMMARY OF THE INVENTION

In one form the invention provides a battery suitable to deliver stored energy at above 150° C. (preferably at above 180° C.; even more preferably at 190° C. or above), for a period of greater than one hour (preferably greater than five hours). There is a cathode comprising carbon monofluoride, an anode comprising a base material selected from the group consisting of silicon, germanium and tin (wherein the base material is lithiated), and an electrolyte.

In a preferred form the anode comprises at least 90% by weight of silicon and is lithiated to at least a five micron depth at at least one position. In that form the electrolyte may comprise a solvent material selected from the group consisting of tetraglyme, propylene carbonate and organosilicon compounds.

For example, the electrolyte may comprise a solvent material having an ethylene oxide chain. In this regard, tetraglyme is tetraethylene glycol dimethyl ether, an ethylene oxide based solvent.

Where the electrolyte comprises an organosilicon compound, it is preferred that it have a flash point above 180° C. For this purpose flash point has been defined using the test of ASTM D3828-09.

For example, the organosilicon compound may comprise one or more of the following moieties:

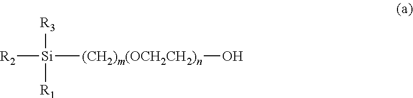

wherein R₁, R₂ and R₃ are the same or different, and each is selected from the group consisting of alkyl moieties of less than five carbons; and
wherein m and n are the same or different and equal to or higher than 1 and lower than 10;

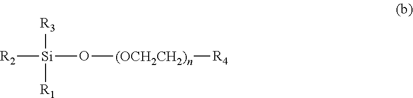

wherein R₁, R₂, R₃ and R₄ are the same or different, and each is selected from the group consisting of alkyl moieties of less than five carbons; and
wherein n is equal to or higher than 1 and lower than 10;

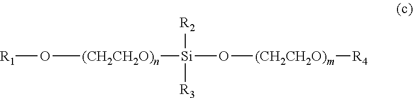

wherein R₁, R₂, R₃ and R₄ are the same or different, and each is selected from the group consisting of alkyl moieties of less than five carbons; and
wherein n and m are the same or different and are equal to or higher than 1 and lower than 10; or
(d)

R₁R₂R₃Si—O—(CH₂CH₂O)ₙ—SiR₄R₅R₆
wherein R₁, R₂, R₃, R₄, R₅ and R₆ are the same or different, and each is selected from the group consisting of alkyl moieties of less than five carbons; and wherein n is equal to or higher than 1 and lower than 10.

We propose that a separator be used (such as one that comprises a glass fiber material), and that the electrolyte further comprise a lithium salt. Preferred lithium salts are selected from the group consisting of lithium-tetrafluoroborate, lithium hexafluorophosphate, lithium-bis(trifluoromethyl-sulfonyl)imide, and lithium bis-(oxalatoborate), with lithium tetrafluoroborate currently considered by us as most preferred.

In one form the cathode may abut a metallic current collector that has been bonded to the cathode's mixture of carbon monofluoride, a binder, and carbon black.

In another aspect the invention provides methods of using such batteries to deliver stored energy After obtaining such a battery (with energy stored therein), one exposes the battery to a temperature above 150° C. (preferably above 180° C.) and delivers stored energy from the battery at that temperature for more than one hour (preferably more than five hours).

From the present disclosure it will be appreciated that one can generate electricity using a conventional energy source, use that electricity to charge a battery of the present invention, and then use a battery of the present invention as a power source at highly elevated temperatures. Batteries of the present invention are mostly intended for use as non-rechargeable batteries, and thus are designed for applications where this is acceptable. They can be produced at acceptable cost, store significant quantities of energy, deliver that energy in a responsive manner, and be reliable for long term use.

other expected advantages of batteries of the present invention are (1) reduced degrading chemical reactivity, as Li intercalated into the Si/Ge/Sn is expected to be less reactive than bare Li, and (2) reliable operation at very high temperatures. When used in conjunction with selected high temperature resistant electrolytes this should provide a pathway to high-temperature batteries operating well above the maximum temperature of the existing technology.

The above and still other advantages of the present invention will be apparent from the description that follows. It should be appreciated that the following description is merely of preferred embodiments of the invention. The claims should therefore be looked to in order to understand the full claimed scope of the invention.

### BRIEF DESCRIPTION OF THE DRAWINGS

FIG. 1 is a schematic exploded view of a prior art type of lithium/carbon monofluoride battery;

FIG. 2 is a schematic depiction of a portion of a preferred battery of the present invention;

FIG. 3 depicts certain preferred organosilicon electrolyte components;

FIG. 4 depicts equipment for lithiating silicon;

FIG. 5A presents test data from experiments using a preferred anode of the present invention with tetraglyme as the electrolyte solvent, at 200° C.; and

FIG. 5B presents test data from similar experiments, but at 190° C. with propylene carbonate as the electrolyte solvent.

### DESCRIPTION OF THE PREFERRED EMBODIMENTS

Described in detail below are batteries suitable for use at highly elevated temperatures. They have an anode based on Si with lithium intercalated into this base material. It is alternatively proposed to use lithiated Si alloy anodes (e.g. lithiated Si/Sn), and/or lithiated Ge anodes, or lithiated Sn anodes.

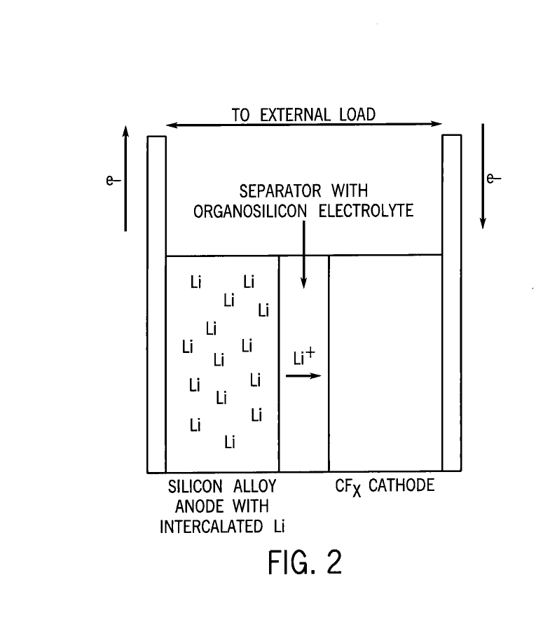

As shown in FIG. 2, a lithiated silicon anode can be coupled to a carbon monofluoride cathode, and a suitable electrolyte can be provided. On the right is the carbon monofluoride cathode, and in the center is the electrolyte that is impregnated into a “separator” that prevents physical contact of the anode and cathode while allowing Li⁺ ions to be transported between them via a liquid electrolyte.

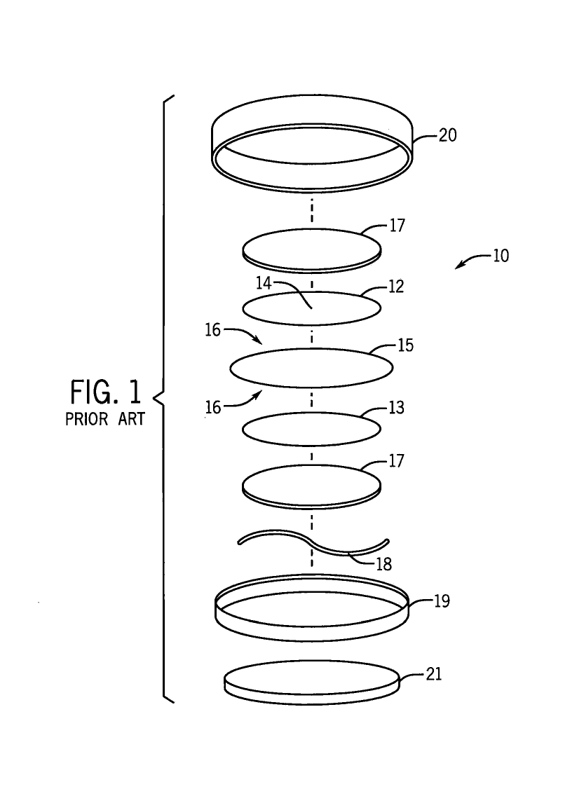

In one application of our invention a FIG. 1 type device can have its standard electrolyte replaced with a selected electrolyte solvent (e.g. tetraglyme, polypropylene carbonate, or selected high temperature resistant organosilicons are preferred). It is projected that certain high temperature resistant sulfones may also prove suitable. The separator can be made of a temperature resistant glass fiber or ceramic material.

The outer housing 20/21 could remain of stainless steel. The stainless steel current collector 14 could be a single ring.

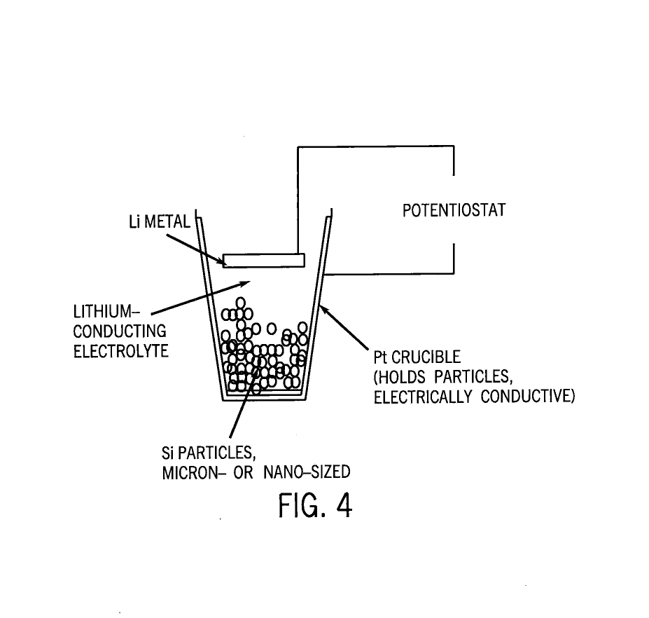

Intercalation of lithium into silicon or Si/Ge/Sn materials can be achieved in several different ways, preferably to at least five microns, more preferably to at least ten microns. One approach, as schematically depicted in FIG. 4, uses a small batch reactor having a platinum crucible. One places nanosized or microsized silicon particles adjacent a bare lithium metal electrode, and applies a controlled electrochemical potential from a potentiostat (approximately 50 millivolts-100 mV) to drive Li⁺ from the bare lithium metal into silicon nanoparticles, thereby forming lithiated silicon particles. The particles are then removed, cleaned, and incorporated into anodes by pressing or other techniques. Optionally one could also add binders and conductivity enhancers.

Alternatively, one could assemble a half cell with nano Si (in wafer chip form) and Li metal foil electrodes. Tetraglyme with LiBF₄ can be the electrolyte for the half cell. One could then provide a charge to the Si electrode (0.25-0.5 volts) versus Li/Li⁺. This will provide lithium to intersperse into the silicon. The resulting LiSi electrode can then be used as the anode in our battery. It is preferred that at least 5 milliamp hours of such a charge be used.

As another embodiment, one could adapt the method developed for lithium-drifted silicon for use in nuclear detectors. See e.g. F. Goulding et al., An Automatic Lithium Drifting Apparatus For Silicon And Germanium Detectors, 11 IEEE Transactions on Nuclear Science 286-290 (or UCRL-11261 1-8)(1964). In this method lithium metal is deposited onto the surface of silicon, and a small electrochemical current is used at modest elevated temperatures to drive the lithium into the silicon.

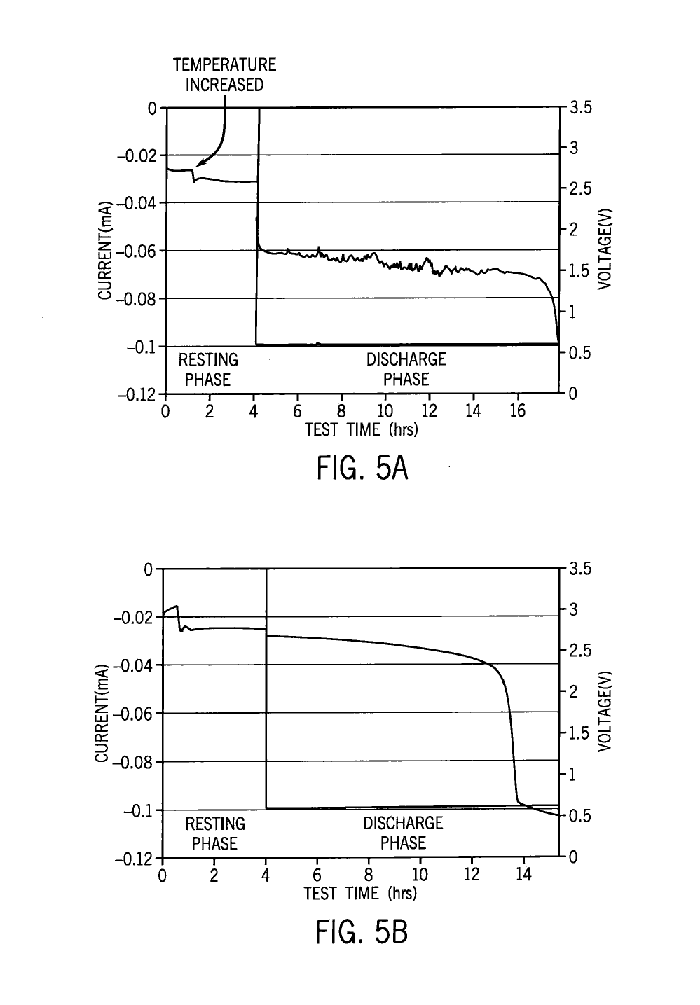

Preferred electrolytes comprise those that are highly temperature resistant and suitable for use in a lithium environment. We find that (as evidenced by FIG. 5A) tetraglyme works well even at 200° C., albeit with a fairly deep level of lithiation. We have also conducted a similar experiment with the electrolyte being propylene carbonate (with LiBF₄) at 190° C., again with good results (See FIG. 5B).

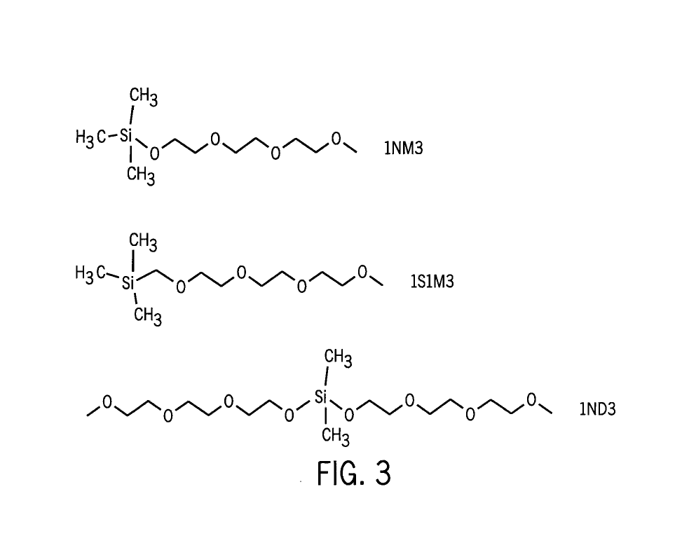

We alternatively propose that a variety of organosilicon solvents (e.g. those of FIG. 3) plus lithium salts could be substituted. In this regard, 1NM3 is representative of a class of compounds in which an ethylene glycol chain is coupled to a trimethylsilyl group via an Si—O—C linkage. This type of compound (and analogs with ethylene glycol chains of different lengths) are good lithium ion conductors.

1S1M3 is representative of a family of compounds that couple an ethylene glycol oligomeric chain to a trimethylsilyl group via a Si—C linkage. This direct Si—C linkage makes the compounds more resistant to hydrolysis and may confer improved stability.

1ND3 is representative of a family of compounds that couple two ethylene glycol oligomeric chains to a single dimethylsilyl group. These compounds have very high boiling points and are likely to enable operation at very high temperatures.

2NM₂4 (Me₃Si—O—(CH₂CH₂O)₄—SiMe₃) is representative of a family of compounds having ethylene oxide chains and a trimethylsilyl terminal group at both ends.

Regardless, the electrolyte solvents (e.g. tetraglyme, propylene carbonate or organisolicon) should have added to them a salt to render them electrically conductive. For example, we propose use of LiBF₄ (which was successfully used in the FIG. 5A and 5B experiments). We suggest mixing the solvent material with a salt (e.g. over a period of 4 to 24 hours), using about 1M lithium salt.

The cathode is preferably a composite material of 90% or so carbon monofluoride (Advance Research Chemical, CAS# 51311-17-2), and about 5% each of a binder and carbon black. The carbon monofluoride acts as the cathode's active material, the binder holds the cathode together, and the carbon black is an additive to increase the electronic conductivity of the composite.

One possible binder is N-methyl-2-pyrrolidone. Another is carboxymethyl cellulose.

As an example of high temperature operation, we formed a lithiated silicon anode by the above methods, and formed a battery using such a carbon monofluoride cathode. We tested these electrodes with tetraglyme and LiBF₄ at 25° C. and then at 200° C. (results from the latter being depicted in FIG. 5A), and recorded the results. Voltage continued more than five hours after testing began at both temperatures.

While a number of embodiments of the present invention have been described above, the present invention is not limited to just these disclosed examples. In this regard we propose production of lithiated silicon alloy, or lithiated germanium, or lithiated tin based anodes by similar techniques, or in accordance with the techniques published in the above cited articles. The result would then be used in similar fashion as the anode.

Further, as the temperature of desired operation increases still further it may also be desirable to modify the materials that other portions of the FIG. 1 battery are made of for even greater temperature resistance. These and other modifications are meant to be within the scope of the invention and claims. Thus, the claims should be looked to in order to judge the full scope of the invention.

### INDUSTRIAL APPLICABILITY

The present invention provides improved batteries capable of high temperature operation.

what is claimed is:

1. A battery suitable to deliver stored energy at above 150° C. for a period of greater than one hour, comprising:
a cathode comprising carbon monofluoride;
an anode comprising a base material selected from the group consisting of silicon, germanium and tin, wherein the base material is lithiated; and
an electrolyte.

2. The battery of claim 1, wherein the anode comprises lithiated silicon.

3. The battery of claim 2, wherein the anode comprises at least 90% by weight of silicon.

4. The battery of claim 3, wherein the anode is lithiated to at least a five micron depth at at least one point.

5. The battery of claim 1, wherein the electrolyte comprises a material selected from the group consisting of tetraglyme, propylene carbonate and organosilicon compounds.

6. The battery of claim 5, wherein the electrolyte comprises an organosilicon compound comprising the following moiety: 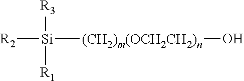
wherein R₁, R₂ and R₃ are the same or different, and each is selected from the group consisting of alkyl moieties of less than five carbons; and
wherein m and n are the same or different and equal to or higher than 1 and lower than 10.

7. The battery of claim 5, wherein the electrolyte comprises an organosilicon compound comprising the following moiety: 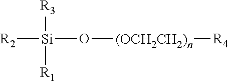
wherein R₁, R₂, R₃ and R₄ are the same or different, and each is selected from the group consisting of alkyl moieties of less than five carbons; and
wherein n is equal to or higher than 1 and lower than 10.

8. The battery of claim 5, wherein the electrolyte comprises an organosilicon compound comprising the following moiety: 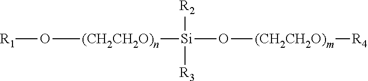
wherein R₁, R₂, R₃ and R₄ are the same or different, and each is selected from the group consisting of alkyl moieties of less than five carbons; and
wherein m and n are the same or different and equal to or higher than 1 and lower than 10.

9. The battery of claim 5, wherein the electrolyte comprises an organosilicon compound comprising the following moiety:
R₁R₂R₃Si—O—(CH₂CH₂O)ₙ—SiR₄R₅R₆
wherein R₁, R₂, R₃, R₄, R₅ and R₆ are the same or different, and each is selected from the group consisting of alkyl moieties of less than five carbons; and
wherein n is equal to or higher than 1 and lower than 10.

10. The battery of claim 1, wherein the separator comprises a glass fiber material.

11. The battery of claim 1, wherein the electrolyte further comprises a salt.

12. The battery of claim 11, wherein the salt is a lithium salt.

13. The battery of claim 12, wherein the lithium salt is selected from the group consisting of lithium-tetrafluoroborate, lithium hexafluorophosphate, lithium-bis (trifluoromethyl-sulfonyl) imide, and lithium bis-(oxalatoborate).

14. The battery of claim 13, wherein the lithium salt is lithium tetrafluoroborate.

15. A method of using a battery to deliver energy, comprising:
obtaining a battery comprising:
a cathode comprising carbon monofluoride;
an anode comprising a base material selected from the group consisting of silicon, germanium and tin, wherein the base material is lithiated; and
an electrolyte; and
exposing the battery to a temperature at or above 150° C. and delivering stored energy from the battery at or above 150° C. for a period of at least one hour.

16. The method of claim 15, wherein the anode comprises lithiated silicon and one delivers stored energy from the battery at or above 150° C. for a period of at least five hours.

17. The method of claim 15, wherein one delivers stored energy from the battery at or above 180° C. for a period of at least one hour.
